(19) United States
(12) Patent Application Publication
(10) Pub. No.: US 2026/0333111 A1
(43) Pub. Date: Oct. 22, 2026

(54) FRAMEWORK FOR LEARNING THE PHYSICAL ENVIRONMENT FOR EFFICIENT DOWNLINK DATA TRANSMISSION IN MIMO SYSTEMS

(71) Applicant: Samsung Electronics Co., Ltd., Suwon-si (KR)

(72) Inventors: Pranav Madadi, Sunnyvale, CA (US); Yan Xin, Princeton, NJ (US); Jianzhong Zhang, Dallas, TX (US)

(21) Appl. No.: 19/637,903

(22) Filed: Apr. 2, 2026

Related U.S. Application Data
(60) Provisional application No. 63/791,255, filed on Apr. 18, 2025.

(51) Int. Cl. H04W 28/02; H04L 5/00; H04W 28/16

(52) U.S. Cl. CPC H04W 28/0226; H04L 5/0048; H04W 28/16

(57) ABSTRACT

Apparatuses and methods for operating a base station (BS) are provided. In some embodiments, the method includes receiving supporting information from at least one external device. The method further includes determining physical environment information based on the supporting information, receiving position information for a user equipment (UE), and generating output information for communication with the UE based on the physical environment information and the position information using at least one learning model.

### CROSS-REFERENCE TO RELATED APPLICATION AND CLAIM OF PRIORITY

This application claims priority under 35 U.S.C. § 119 (e) to U.S. Provisional Patent Application No. 63/791,255 filed on Apr. 18, 2025. The above-identified provisional patent application is hereby incorporated by reference in its entirety.

### TECHNICAL FIELD

This disclosure relates generally to multiple input multiple output (MIMO) systems. More specifically, this disclosure relates to apparatuses and methods learning the physical environment information for efficient downlink data transmission in MIMO systems.

### BACKGROUND

In future wireless networks, such as 6G, there is a need for higher downlink (DL) throughput and lower latency. Many technical advancements have been made to that effect such as multi-user multiple input multiple output (MU-MIMO) systems that significantly increase spectral efficiency by exploiting the spatial degrees of freedom. For typical implementations for DL data transmission in such MIMO systems, the base station (BS) needs to be aware of the channel to the user and design effective precoders to minimize interference and maximize total sum rate. To design effective precoders for DL transmission, there is a need for periodic pilot transmission, channel estimation and channel feedback.

### SUMMARY

This disclosure provides apparatuses and methods learning the physical environment information for efficient downlink data transmission in MIMO systems.

In one embodiment, a method for operating a base station (BS) is provided. The method includes receiving supporting information from at least one external device. The method further includes determining physical environment information based on the supporting information, receiving position information for a user equipment (UE), and generating output information for communication with the UE based on the physical environment information and the position information using at least one learning model.

In another embodiment, a BS is provided. The BS includes a transceiver, a backhaul or network interface, at least one processor including processing circuitry operably coupled to the transceiver and the backhaul or network interface; and a memory storing instructions, wherein the instructions, when executed by the at least one processor individually or collectively, cause the BS to: receive, via at least one of transceiver and the backhaul or network interface, supporting information from at least one external device, determine physical environment information based on the supporting information, receive position information for UE, and generate output information for communication with the UE based on the physical environment information and the position information using at least one learning model.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2A illustrates an example BS according to embodiments of the present disclosure;

FIG. 2B illustrates an example server 250, according to embodiments of the present disclosure;

FIG. 3 illustrates an example of a UE according to embodiments of the present disclosure;

FIG. 4 illustrates a framework the interactions of a BS in a cell with external devices and an end user according to embodiments of the present disclosure;

FIG. 5A illustrates a flowchart of an example method of a BS for determining physical environment information according to embodiments of the present disclosure;

FIG. 5B illustrates an example procedure of the BS determining the physical environment information according to embodiments of the present disclosure;

FIG. 6 illustrates an example implementation of a learning model according to embodiments of the present disclosure;

FIG. 7 illustrates a flowchart of an example method of communication from at least one external device to a BS while the BS determines the physical environment information according to embodiments of the present disclosure;

FIG. 8A illustrates a flowchart of an example method of a BS generating output information for a UE using at least one learning model according to embodiments of the present disclosure;

FIG. 8B illustrates an example procedure of the BS generating output information for a UE using at least one learning model according to embodiments of the present disclosure;

FIG. 9 illustrates a flowchart of an example method of a BS generating output information for a UE using at least one learning model from the perspective of the UE according to embodiments of the present disclosure;

FIG. 10 illustrates an example implementation of a learning model according to embodiments of the present disclosure;

FIG. 11 illustrates an example implementation of a multi-modal transformer-based learning model with time series data used to learn channel at future time steps according to embodiments of the present disclosure; and

FIG. 12 illustrates a flowchart of an example method of the BS generating output communication with the UE using at least one learning model according to embodiments of the present disclosure.

### DETAILED DESCRIPTION

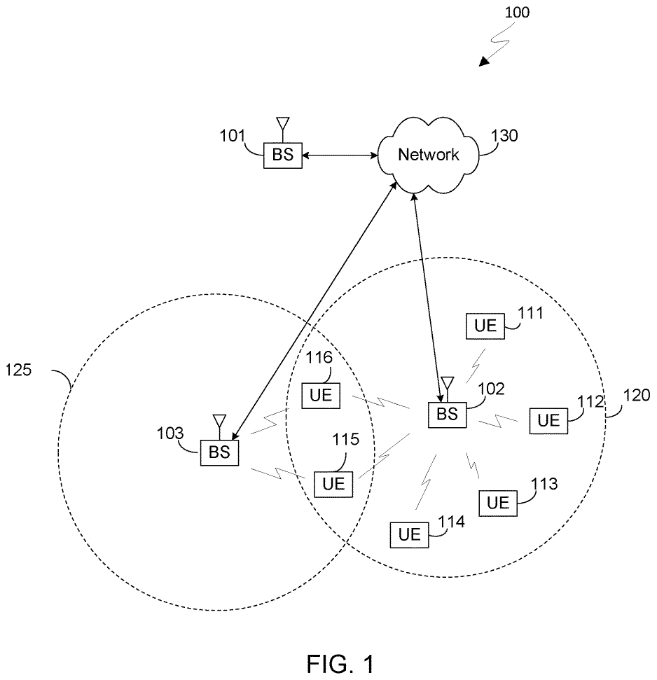

FIGS. 1-12, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In future wireless networks, such as 6G, there is a need for higher downlink (DL) throughput and lower latency. Many technical advancements have been made to that effect such as multi-user multiple input multiple output (MU-MIMO) systems that significantly increase spectral efficiency by exploiting the spatial degrees of freedom. For typical implementations for DL data transmission in such MIMO systems, the base station (BS) needs to be aware of the channel to the user and design effective precoders to minimize interference and maximize total sum rate. To design effective precoders for DL transmission, there is a need for periodic pilot transmission, channel estimation and channel feedback.

In time division duplex (TDD) systems, a user sends uplink (UL) pilot signals, using which BS estimates the channel. In frequency division duplex (FDD) systems, a BS sends pilots to user which is used to estimate the channel at the user. The estimated channel state information (CSI) is then sent to the BS using feedback mechanisms. Once the channel information is available at the BS, it has to design precoders. These various operations often result in high overhead and inaccurate channels at the BS either due to bad channel estimation (in TDD systems) and poor channel feedback (in FDD systems).

This disclosure relates to a framework, for a BS to learn its physical environment information, i.e., a radio frequency (RF) transmission field referred to herein as “external device(s)” or “external entities” which can include, but is not limited to, sensors, radars, fixed wireless nodes, edge compute devices, external controllers, or the like. Once the BS learns its environment, it can leverage this for efficient DL transmission by either designing precoders or by effective channel estimation.

With the BS being aware of its physical environment information it can effectively estimate channel to any geolocation within its cell. With limited UL data from the user, which might include but not limited to position report such as global positioning system (GPS) coordinates, the BS can design precoders and do DL transmission. This will devoid for the need for cumbersome pilot transmission, channel estimation and precoder design framework which helps in reducing overhead with effective transmission.

Artificial intelligence (AI) is making a huge stride today and there can be some multi-model vision and speech transformer-based models which attempt to tackle various problems. These models can process data from multiple modalities such as speech, images and can be trained for various downstream tasks. In accordance with the disclosed technology, information from various external device(s) deployed in the given cell, can be aggregated at the BS and be used to learn the RF field.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or another data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the BSs and/or one or more of the UEs 111-116 include a framework for learning the physical environment information for efficient downlink data transmission in MIMO systems.

Although FIG. 1 illustrates one example of a wireless network, various changes may be made to FIG. 1. For example, the wireless network could include any number of BSs and any number of UEs in any suitable arrangement. Also, the BS 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

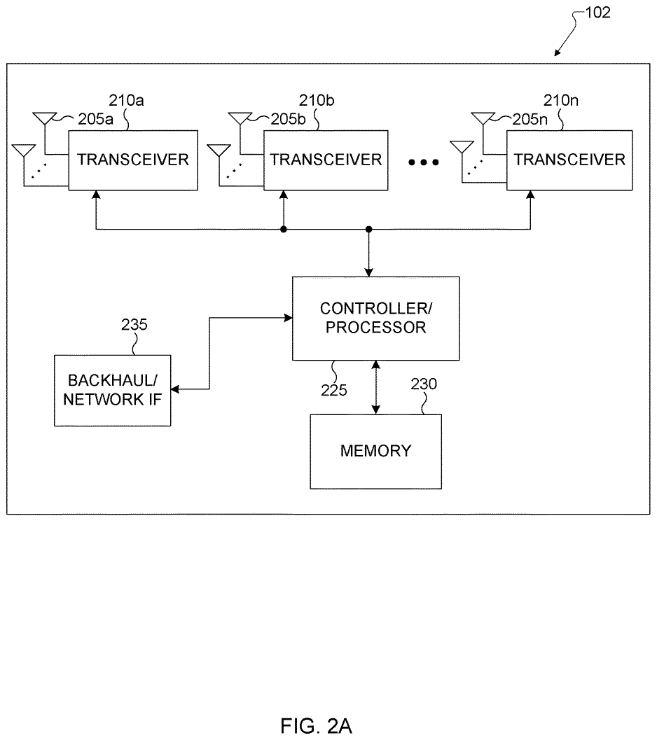

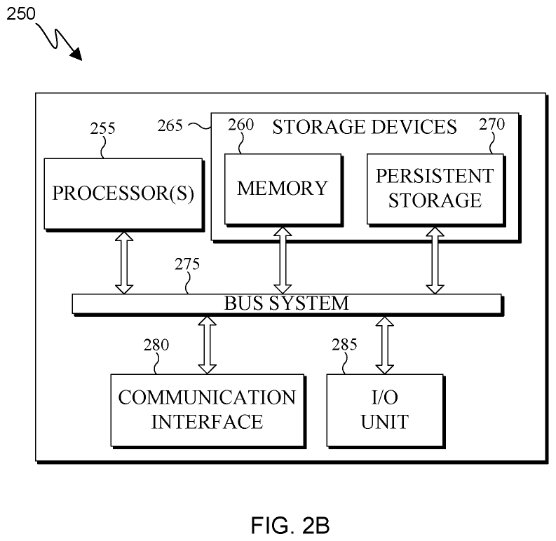

FIG. 2A illustrates an example gNB 102 according to embodiments of the present disclosure. The embodiment of the gNB 102 illustrated in FIG. 2A is for illustration only, and the gNBs 101 and 103 of FIG. 1 could have the same or similar configuration. However, gNBs come in a wide variety of configurations, and FIG. 2A does not limit the scope of this disclosure to any particular implementation of a gNB.

As shown in FIG. 2A, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for a framework for learning the physical environment information for efficient downlink data transmission in MIMO systems as described in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2A illustrates one example of gNB 102, various changes may be made to FIG. 2A. For example, the gNB 102 could include any number of each component shown in FIG. 2A. Also, various components in FIG. 2A could be combined, further subdivided, or omitted and additional components could be added according to particular needs.

FIG. 2B illustrates an example server 250, according to embodiments of the present disclosure. The server 250 can represent one or more encoders, decoders, local servers, remote servers, clustered computers, and components that act as a single pool of seamless resources, a cloud-based server, and the like. The server 250 can be accessed by one or more of the UEs 111-115 and/or the BS 102 of FIG. 1 or another server.

As shown in FIG. 2B, the server 250 can represent one or more local servers, one or more compression servers, or one or more encoding servers, such as an encoder. In certain embodiments, the encoder can perform decoding. As shown in FIG. 2B, the server 250 includes a bus system 275 that supports communication between at least one processing device (such as a processor 255), at least one storage device 265, at least one communications interface 280, and at least one input/output (I/O) unit 285.

The processor 255 executes instructions that can be stored in a memory 260. The processor 255 can include any suitable number(s) and type(s) of processors or other devices in any suitable arrangement. Example types of processors 255 include microprocessors, microcontrollers, digital signal processors, field programmable gate arrays, application specific integrated circuits, and discrete circuitry.

The memory 260 and a persistent storage 235 are examples of storage devices 265 that represent any structure(s) capable of storing and facilitating retrieval of information (such as data, program code, or other suitable information on a temporary or permanent basis). The memory 260 can represent a random access memory or any other suitable volatile or non-volatile storage device(s). For example, the instructions stored in the memory 260 can include instructions for learning the physical environment information for efficient downlink data transmission in MIMO systems. The persistent storage 270 can contain one or more components or devices supporting longer-term storage of data, such as a read only memory, hard drive, Flash memory, or optical disc.

The communications interface 280 supports communications with other systems or devices. For example, the communications interface 280 could include a network interface card or a wireless transceiver facilitating communications over the network 102 of FIG. 1. The communications interface 280 can support communications through any suitable physical or wireless communication link(s).

The I/O unit 285 allows for input and output of data. For example, the I/O unit 285 can provide a connection for user input through a keyboard, mouse, keypad, touchscreen, or other suitable input device. The I/O unit 285 can also send output to a display, printer, or other suitable output device. Note, however, that the I/O unit 285 can be omitted, such as when I/O interactions with the server 250 occur via a network connection.

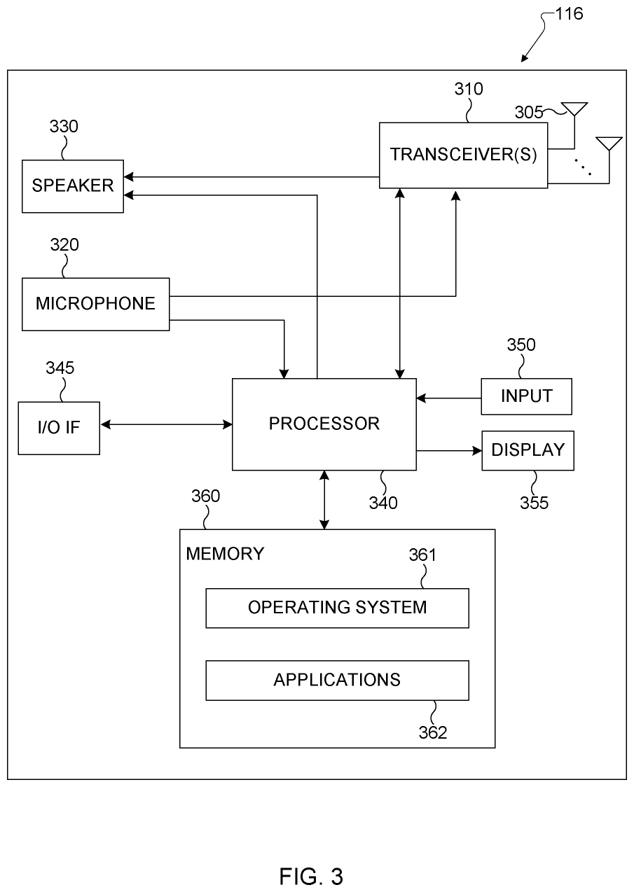

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. For example, in various embodiments, the UE 116 uses a framework for learning the physical environment information for efficient downlink data transmission in MIMO systems.

In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

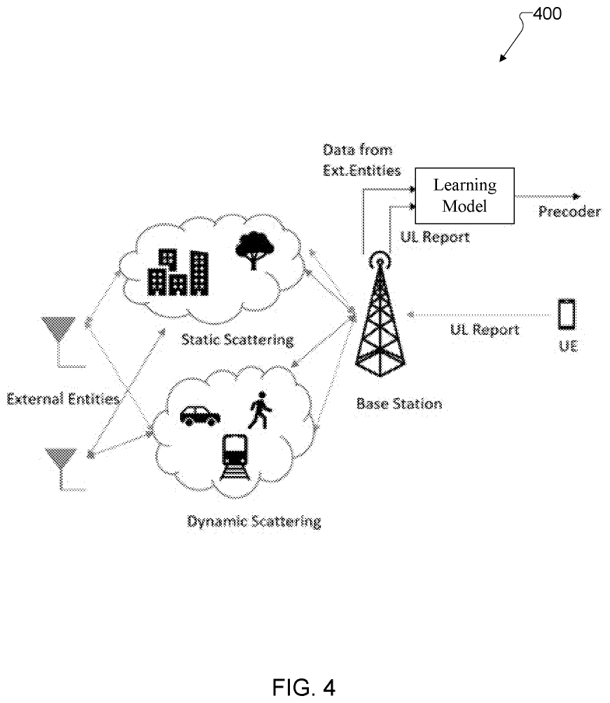

FIG. 4 illustrates a framework 400 the interactions of a BS 102 in a cell with external devices and an end user according to embodiments of the present disclosure.

In one or more embodiments, the BS 102 can learn its physical environment information, i.e., the RF transmission field with help of what is referred to in the disclosed technology as “external devices” or “external entities” which includes but not limited to sensors, radars, fixed wireless nodes, edge compute devices. Once the BS 102 learns its environment, it can leverage this for efficient DL data transmission by either designing precoders or by effective channel estimation.

With the BS 102 being aware of its physical environment information it can effectively estimate channel to any geolocation within its cell. With limited UL data from the user which might include but not limited to position report such as GPS coordinates, the BS 102 can design precoders and do DL transmission. This will devoid for the need for cumbersome pilot transmission, channel estimation and precoder design framework which helps in reducing overhead with effective transmission.

AI is making a huge stride today and there can be some multi-model vision and speech transformer-based models which attempt to tackle various problems. These learning models can process data from multiple modalities such as speech, images and can be trained for various downstream tasks. In accordance with the disclosed technology, information from various external device(s) deployed in the given cell, can be aggregated at the BS 102 and be used to learn the RF field.

Given the idea of having the BS 102 learn the RF environment, there needs to be detailed signaling between the BS 102 and such device(s) for learning and also with users for implementing data transmission without the need for pilot transmissions, channel estimation. An example of such signaling is illustrated in FIG. 4.

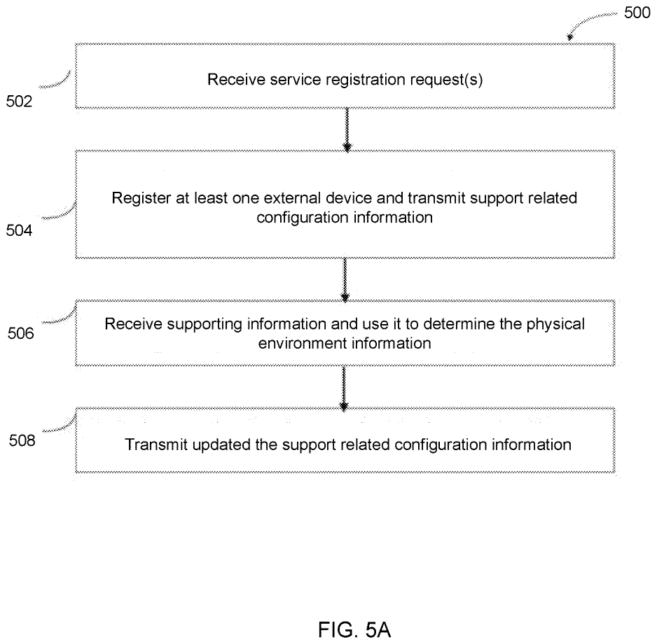

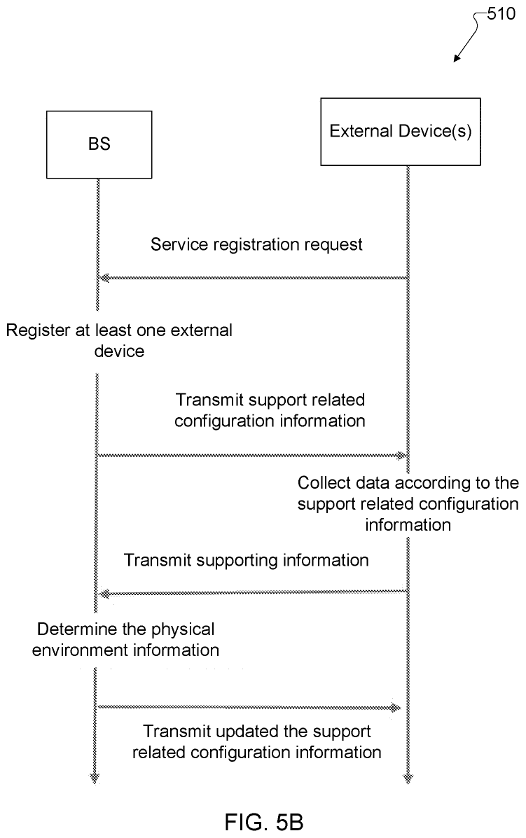

FIG. 5A illustrates a flowchart of an example method 500 of a BS 102 for determining physical environment information according to embodiments of the present disclosure. FIG. 5B illustrates an example procedure 510 of the BS 102 determining the physical environment information according to embodiments of the present disclosure. The embodiment of the method 500 and the procedure 510 shown in FIGS. 5A-5B is for illustration only. Other embodiments of the method 500 and the procedure 510 for determining physical environment information could be used without departing from the scope of this disclosure.

The BS 102 learns the physical environment information with the help of the external device(s), which might include, but is not limited to, radar/lidar sensors, cameras, fixed wireless nodes, and/or edge compute devices for learning the physical environment information, and leverages that in designing efficient DL data transmission schemes.

The method 500 begins with the BS 102 receiving service registration request(s) from the at least one external device (502). In one or more embodiments, the at least one external device communicates the type of service they can provide with the BS 102. This enables the BS 102 to be aware of various resources that is available for it at a given cell location and can deploy relevant learning models (select at least one learning model to execute), which can include AI. In one example, the fixed wireless nodes can perform the initial handshake mechanism with the BS 102 and communicate data transmission parameters included, but not limited to, its data transmission schemes, pilot patterns/locations. In another example, an edge compute device can communicate its compute capabilities. In another example, the external device(s) could be cameras sending video information and during the service registration, various capabilities such as the duration of the video, the angle and focus of the scene being captured, its cache capabilities, and the compression schemes for the video is communicated to the BS 102.

Next, the BS 102 registers the at least one external device, decides on the learning model to be used for learning the physical environment information, and transmits support related configuration information to the relevant external device (504). The BS 102 transmits the support related configuration information based on at least the requirements or goals for training, and service capabilities. In one or more embodiments, the communication with the at least one external device can happen with a specific wireless/wired signal sent from the BS 102. In other embodiments, such communication can be with a centralized controller which can be handling all the external devices such as edge computing devices. In one embodiment, it can configure the type of reporting, which includes but is not limited to, periodic, semi-periodic, aperiodic or trigger-based reporting along with the time of intervals. In other embodiments, it could configure specific external device related configuration information such as duration of video, compression ratio and overhead to be used to sending the data to the cameras. The channel state information-reference signal (CSI-RS) pilot design and allocation to fixed wireless nodes. In one or more embodiments, the at least one external device could be radar targets to be sensed by echo transmission signals sent by the BS 102 and configuration parameters is for the BS 102 to send such periodic signals and capture the echo signals for processing. In one or more embodiments, the service registration request includes temporal support data and the BS 102 can generate a CSI prediction model using the at least one learning model based on the temporal support data.

Next, the BS 102 receives the supporting information from the at least one external device based on the to the support related configuration information and uses the supporting information to learn the physical environment information (506) using the selected learning model(s). In one or more embodiments, the supporting information could be the CSI-RS pilots being sent over by the fixed wireless nodes. In other embodiments, the supporting information could be received echo transmission signals which can be used to extract sensing information such as delay, doppler, angle of arrival etc. In other embodiments, the supporting information could be the images and videos noted above.

In one or more embodiments, the BS 102 changes (or updates) the support related configuration information and transmits updated support related configuration information to the at least one external device (508). In one or more embodiments, operation 508 is optional. The BS 102 is capable of changing (or updating) the support related configuration information based on its observation on performance or by considering semantic information which includes, but is not limited to, possibility of a special event like sports/concerts, time of the day or network key performance indicators such as total number of users served, DL/UL throughput, number of calls drops. The BS 102 changes and/or transmits the updated support related configuration information based on various factors. In one or more embodiments, the BS 102 can decide to modify the frequency at which it should receive the supporting information by changing the time of reporting interval. In another example, it can request to change the orientation of the camera to different angle and increase the duration or quality of the video being sent. In other example, a specific trigger can be sent to the at least one external device requesting supporting information.

As noted above and also described in more detail below, the BS 102 can utilize at least one learning model to determine the physical environment information and/or generate output information from communication with a UE 116 such as a multi-modal transformer based learning model. The output information can include, but is not limited to, precoder information (a precoder matrix) and/or beam index information. There are various learning models, including, but not limited to, transformer-based machine learning (ML) models that can process data from multiple modalities. With various large language models (LLM), vision and speech transformers resources are needed to effectively learn the physical environment information at the BS 102. In one example, the training of a learning model (such as a multi-modal transformer based learning model) can be done offline which can effectively learn the impact of static scattering in the environment and when deployed can use supporting information available from the at least one external device received after triggering them to do effective DL data transmission.

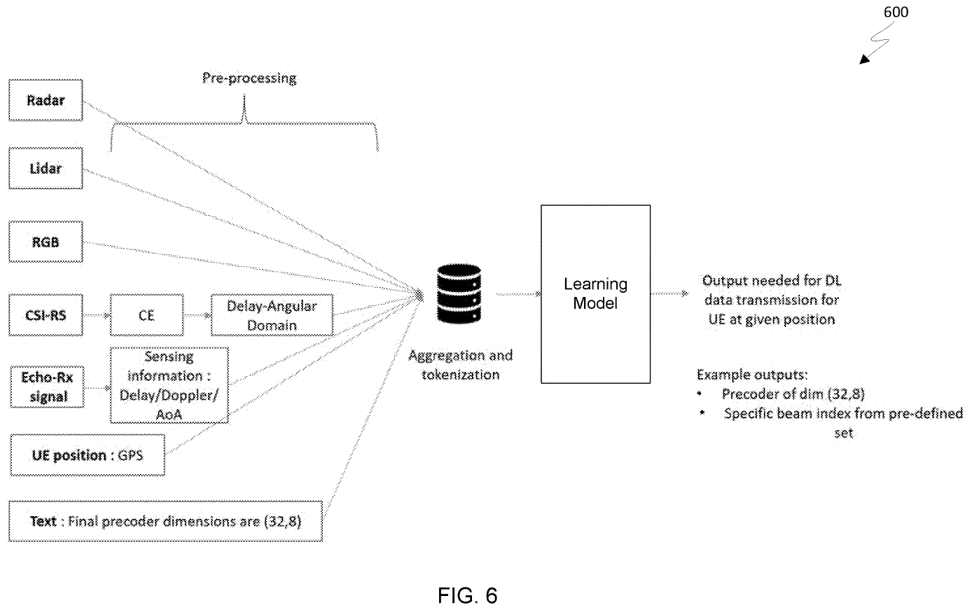

FIG. 6 illustrates an example implementation 600 of a learning model according to embodiments of the present disclosure.

In one or more embodiments, and as noted above, supporting information from at least one external device (and/or position information from the UE 116) can be used as input to the learning model. In one or more embodiments, and as shown in FIG. 6, the learning model can be a multi-modal transformer-based learning model. Although the learning model is illustrated as a multi-modal transformer-based learning model this is for example purposes only, and it is understood any suitable AI/ML model can be used. Furthermore, it is also understood that the learning model can include one or more models that are selected for execution based on a service registration request received by the BS 102 from the at least one external device (the type of external device(s) in the physical environment). As noted above, the supporting information can include, but is not limited to, radar, lidar, RGB images, channel estimation(s) from the received CSI-RS pilots, echo received signals, UE position, text, or the like.

In one or more embodiments, pre-processing steps that can be specific to the type supporting information can be performed on the supporting information, such as extracting the sensing information such as delay, doppler or angle of arrival (AoA) from echo received signals, or estimating the channel using the received CSI-RS pilots from fixed wireless nodes and doing an Inverse Fast Fourier Transform (IFFT) to consider channel in sparse delay-angular domain. The supporting information (which may or may not be pre-processed) is aggregated and tokenized and are used as the input to the learning model.

In one or more embodiments, the learning model can be trained to have effective DL data transmission and thus can have various possible outputs. In one example, the output of the model can be a specific narrow band beam to be used for highest throughput for DL data transmission. In another example, the BS 102 antennas and UE 116 antenna information can be used as textual input to the model and have the model output the precoder matrix to be used. In another example, multiple user position information can be used and can have multiple precoders as output such that the total sum rate is maximized.

As noted above, the BS 102 is capable of changing the supporting information related configuration parameters based on its observation on performance or by considering semantic information (see operation 508 of FIG. 5).

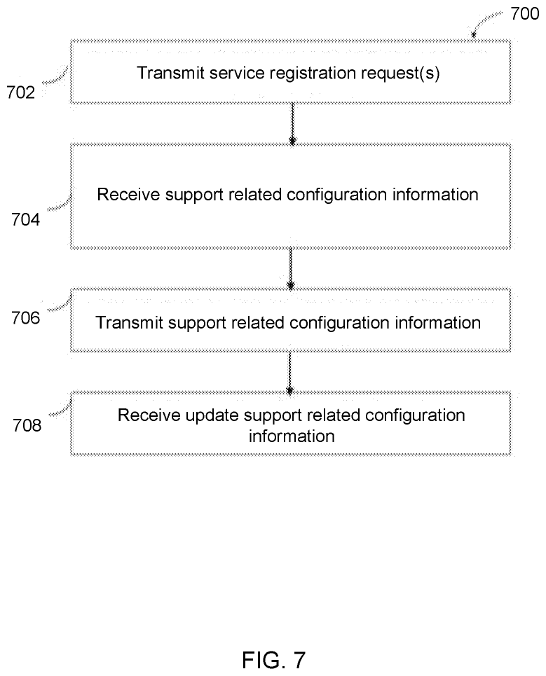

FIG. 7 illustrates a flowchart of an example method 700 of communication from at least one external device to a BS 102 while the BS 102 determines the physical environment information according to embodiments of the present disclosure.

The method 700 begins with the at least one external device performing the service registration with the BS 102 (702). As noted above, performing a service registration includes the at least one external device communicating the type of service (transmitting service registration request(s)) that can be provided with the BS 102. The service registration enables the BS 102 to be aware of various resources that are available at a given cell location so the BS 102 can deploy relevant learning model(s). In one example, fixed wireless nodes can perform the initial handshake mechanism with the BS 102 and communicate data transmission parameters included but not limited to its data transmission schemes, pilot patterns/locations. In another example, an edge compute device can communicate its compute capabilities. In another example, the at least one external device could be cameras sending video information and during the service registration, various capabilities such as the duration of the video, the angle and focus of the scene being captured, its cache capabilities, and the compression schemes for the video to the BS 102.

Next, the at least one external device receives support related configuration information from the BS 102 (704). In one or more embodiments, and as noted above, the BS 102 can transmit the support related configuration information using a specific wireless/wired signal. In one embodiment, the BS 102 can configure the type of reporting for the support related configuration information, which includes but not limited to periodic, semi-periodic, aperiodic or trigger-based reporting along with the time of intervals. In other embodiments, the BS 102 could configure specific entity related configuration information such as duration of video, compression ratio and overhead to be used to sending the data to the cameras, the CSI-RS pilot design, allocation to fixed wireless nodes, or the like.

Based on the support related configuration information, the at least one external device transmits the supporting information to the BS 102 (706). In one or more embodiments, transmitting the supporting information may include the at least one external device performing local computation(s). In one or more embodiments, the local computation(s) may be required depending on the external device, and the configuration agreed between the BS 102 and the at least one external device. In one embodiment, where the at least one external device is a fixed wireless node, the supporting information is the pilots such as CSI-RS being sent to the BS 102 and in other embodiments, it could be the audio and video clips of certain duration or a just a snapshot in time compressed according to the configuration parameters.

Based on the supporting information, the at least one external device receives updated (or modified) support related configuration information from the BS 102 (708). As noted above, receiving updated support related configuration information is optional. The at least one external device updates accordingly based on the updated support related configuration information. In one example, an external device can receive modifications to the frequency at which it should send the supporting information by changing the time of reporting interval. In another example, an external device can receive a request to change the orientation of the camera to different angle and increase the duration or quality of the video being sent. In another example, a specific trigger can be received from the BS 102 requesting supporting information.

In one or more embodiments, now that the BS 102 is aware of the physical environment information (RF transmission field), the BS 102 advantageously only requires the serving user's (UE's) position to effectively design precoders for DL data transmission.

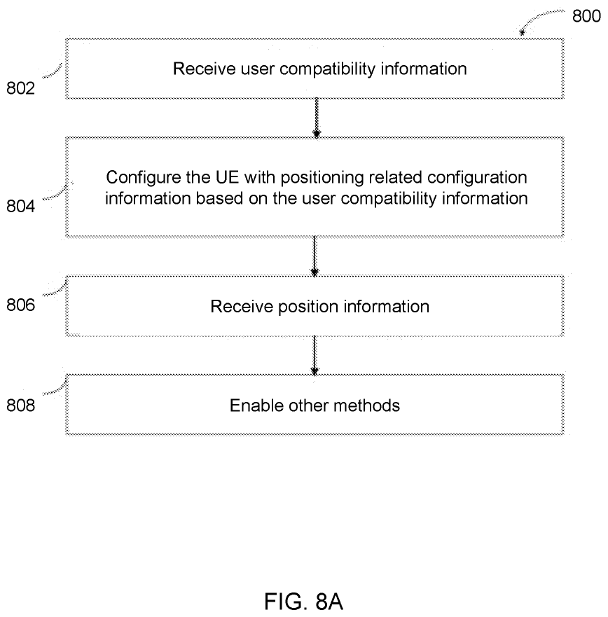

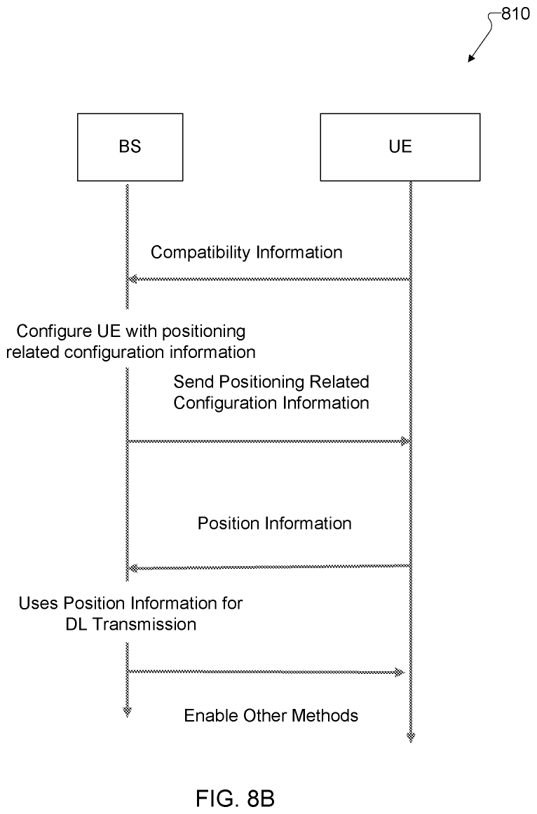

FIG. 8A illustrates a flowchart of an example method 800 of a BS 102 generating output information for a UE 116 using at least one learning model according to embodiments of the present disclosure. FIG. 8B illustrates an example procedure 810 of the BS 102 generating output information for a UE 116 using at least one learning model according to embodiments of the present disclosure. The embodiment of the method 800 and the procedure 810 shown in FIGS. 8A-8B is for illustration only. Other embodiments of the method 800 and the procedure 810 for determining physical environment information could be used without departing from the scope of this disclosure.

The method 800 begins with the BS 102 receiving user compatibility information from the UE 116 (802). The compatibility information can be a compatibility report (UE compatibility to support UL transmission of a position-report) that can include, but is not limited to, information from specific localization schemes or an encryption of GPS coordinates. In one example, there could be a prompt or a feature on mobile device asking user permission to share its location to network provider for better connectivity and when user agrees to it, the compatibility information can be sent to the BS 102. Similarly, the user can deny permission to share its location and at any given time, and the UE 116 has to communicate this to the BS 102.

In one or more embodiments, the report of the compatibility information can be received via a physical uplink control channel (PUCCH) as an uplink control information (UCI). In another embodiment, a MAC control element (MAC CE) identified by a MAC protocol data unit (MAC PDU) subheader to be carried in a physical uplink shared channel (PUSCH) can be used to indicate UE position-report compatibility.

Next, the BS 102 configures the UE 116 with positioning related configuration information, such as the setting the triggering conditions, and/or reporting intervals of the position reporting (804). In one or more embodiments, part of or all the position related configuration information is transmitted to specific UE's using radio resource control (RRC) messages such as RRC reconfiguration once or at any specific needed time. In one embodiment, a specific IE PositionReportConfigNR can be introduced, which can include various configuration parameters set by the BS 102 that includes but is not limited to as reportInterval for periodic sharing of the report. In another embodiment, the positioning related configuration information can be semi-persistence or aperiodic. For example, the positioning related configuration information can be triggered by the data center interconnect (DCI), where a new field (e.g. 1-bit triggering field) can be introduced to the DCI for the positioning related configuration information triggering.

Next, the BS 102 receives position information from the UE 116 and uses it as an input to the learning model (806). The BS 102 keeps track of performance of data transmission with help of various parameters, including but not limited to negative acknowledgments (NACKS), number of retransmissions, etc. In one example, there could be threshold-based algorithm for parameters under observation that first triggers the at least one external device to send supporting information to update the learning model. This could be due to large number of highly mobile users changing the physical environment information significantly. In one or more embodiments, the BS 102 generates output information for communication with the UE 116 (a DL transmission) based on the determined position information from the UE 116 and the physical environment information determined from the communication with the at least one external device described above (using the learning model).

Next, the BS 102 can enable other methods (808) due to various reasons such as large computations, significant drop in performance, or the UE rescinds permission to share its location. The BS 102 communicates this to the UE 116 using dedicated RRC signaling or DCI. In one or more embodiments, operation 808 is optional.

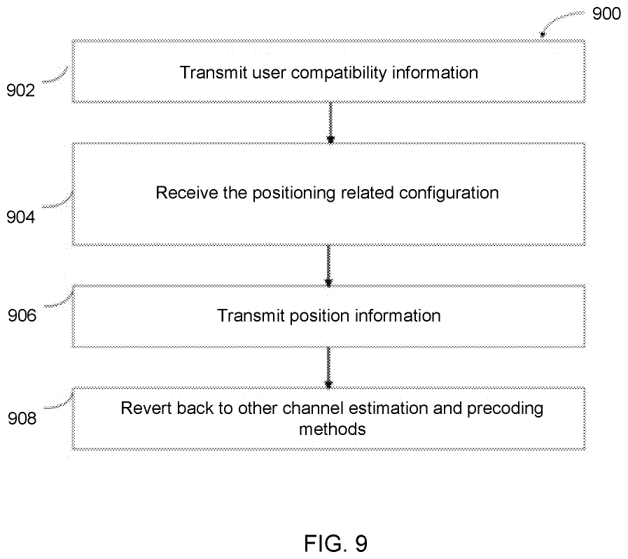

FIG. 9 illustrates a flowchart of an example method of a BS 102 generating output information for a UE 116 using at least one learning model from the perspective of the UE according to embodiments of the present disclosure.

The method 900 begins with the UE 116 transmitting its user compatibility information to support the BS 102 (902). As noted above, the compatibility information can include, but is not limited to, information from specific localization schemes or an encryption of GPS coordinates. In one example, there could be a prompt or a feature on mobile device asking user permission to share its location to network provider for better connectivity and when user agrees to it, the compatibility report can be sent to BS. Similarly, the user can deny permission to share its location and at any given time, and UE 116 communicates this to the BS 102.

As noted above, the report of the compatibility information can be sent via PUCCH as UCI. In another embodiment, a MAC CE identified by a MAC PDU subheader to be carried in a PUSCH can be used to indicate UE position-report compatibility.

Next, the UE 116 receives the positioning related configuration information from the BS 102. such as the setting the triggering conditions, reporting intervals of the position reporting (904). Part of or all the position reporting configuration information is received from RRC messages such as RRC reconfiguration once or at any specific needed time. In one embodiment, a specific IE PositionReportConfigNR can be introduced, which can include various configuration parameters set by the BS that includes but is not limited to as reportInterval for periodic sharing of the report. In another embodiment, the report can be semi-persistence or aperiodic. For example, the report can be triggered by the DCI, where a new field (e.g. 1-bit triggering field) can be introduced to the DCI for the position report triggering.

The UE 116 transmits the position information based on to the position reporting related configuration information to the BS 102 and receives DL data based on the precoding scheme from learning the physical environment information (906).

Next, the UE 116 can receive a request from the BS 102 to change back to the other methods using dedicated RRC signaling or DCI. The UE 116 will also receive the related information including but not limited to the pilot design/locations for channel estimation in TDD, CSI-RS feedback related parameters for FDD systems.

In one or more embodiments, the channel between two components in the physical environment information (the RF transmission field) can be divided into static components due to scattering from trees/building, along with dynamic components due to scattering from cars, trains and humans as shown in the equation below.

$$H = {\sum }_{k = 1}^{{N}_{d}} {β}_{k} {e}^{- 2 π f {v}_{k}} + {\sum }_{k = 1}^{{N}_{s}} {α}_{k} {e}^{- 2 π f {τ}_{k}}$$

The impact of static scattering can remain the same across time and can potentially be learnt offline but the impact of dynamic scattering can change with time and hence the BS 102 may need to receive periodic supporting information from external device(s) to update its understanding of the physical environment information at periodic intervals of time.

Next, the UE 116 can be triggered to revert back to other channel estimation and precoding methods (908). As noted above, the UE can be triggered by the BS to revert back to other channel estimation and precoding methods due to various reasons such as large computations, significant drop in performance, or the UE 116 rescinds permission to share its location. The BS 102 communicates this to the UE 116 using dedicated RRC signaling or DCI. In one or more embodiments, operation 908 is optional

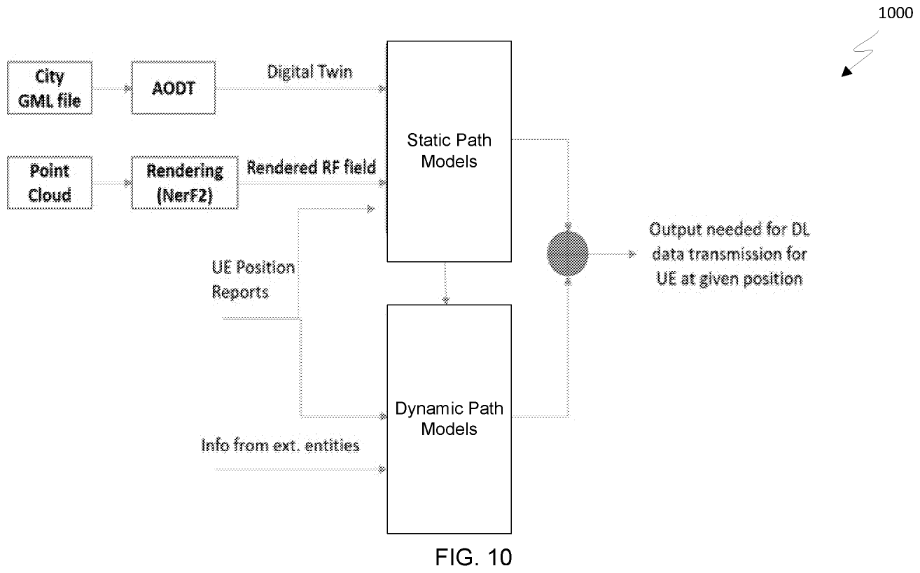

FIG. 10 illustrates an example implementation of a learning model 1000 according to embodiments of the present disclosure.

In one or more embodiments, as shown in FIG. 10, the learning model 1000 can include two different models at the BS 102 that captures the impact of static and dynamic components separately. A static learning model can be learnt offline and a dynamic learning model can be trained online and can use supporting information from external device(s). Such a split will reduce the overload of data transmission as static models capture most of the channel components and is trained offline. This can also improve the efficiency as better tools can be used to train the static models.

In or more embodiments, the static scattering can be studied using rendering techniques. In one or more embodiments, the static scattering can be studied, using but is not limited to, neural network-based scene representation and/or novel-view synthesis which in computer vision can be referred to as neural radiance field. In one or more embodiments, both of the path models can be trained with multi-view images of the scene, the neural radiance field learns the geometry and lighting of a 3D scene and can generate an image from a point-of-view of any given coordinate. Such rendering techniques can also be extended to radio-frequency fields and for any given user location within the cell. A 2D heatmap of spatial spectrum seen at the BS 102 from the RF signals coming from a user at any random location can be generated, essentially leaning the channel between the BS 102 and the user (UE 116).

In one or more embodiments, specific edge computing devices capable of aiding in rendering techniques, including but not limited to point cloud of the cell/scene, RF transmission maps from set of observation points, registers their service to the BS 102 similar to operations 402 and 702 described above. The BS 102 can configure the computing devices and collect the data to train the static learning model offline similar to operations 504/704 in described above.

In one or more embodiments, a digital twin can be used to model the impact of static scattering, which uses geographical information such as geography markup language (CityGML) and three-dimensional spatial data such as platforms like aerial omniverse digital twin (AODT) platform to simulate a digital twin of the physical world. At operation 502 of the previous embodiment, certain computing devices with support for platforms like digital twin can register their capabilities and the BS 102 can then configure them to use it to train its static model using operation 504 of previous embodiment.

Furthermore, to add the impact of dynamic scattering resulting from cars, humans, or the like, the BS 102 interacts with external device as mentioned above, and utilizes the supporting information to update the dynamic learning model for dynamic scattering and combined it with static scattering model to get comprehensive channel.

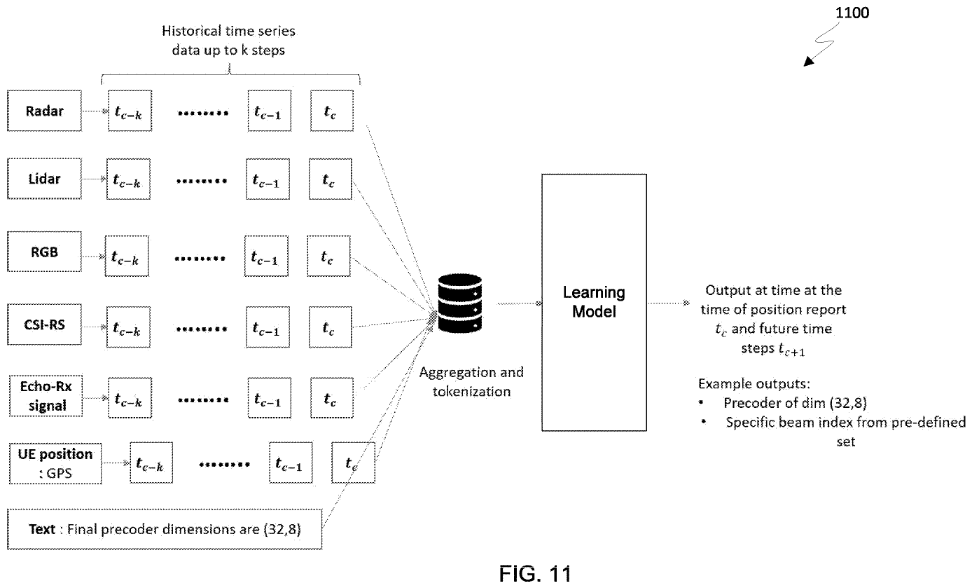

FIG. 11 illustrates an example implementation 1100 of a multi-modal transformer-based learning model with time series data used to learn channel at future time steps according to embodiments of the present disclosure.

As shown in FIG. 11, the multi-modal models can be used to battle the impacts of channel aging. Given the capabilities of AI to deal with time correlations, the input to the model can be a time series of data instead of instantaneous data.

External devices are capable of sending time series data and report it to the BS 102 during the service registration operation 502 described above. In one example, the cameras can communicate its capability to store in its cache, video frames of up to past few seconds. The BS 102 can configure the at least one external device using the operation 504 described above. In one example, the configuration parameters can include the number of time steps, the granularity of data etc. In one example, the position information from the UE 116 can also be a time series, giving as input past k samples. Given a cell has fixed number of paths of transportation for user to move, the prediction model can be easily learned. This can be used to generate the channel at any given possible time in the future.

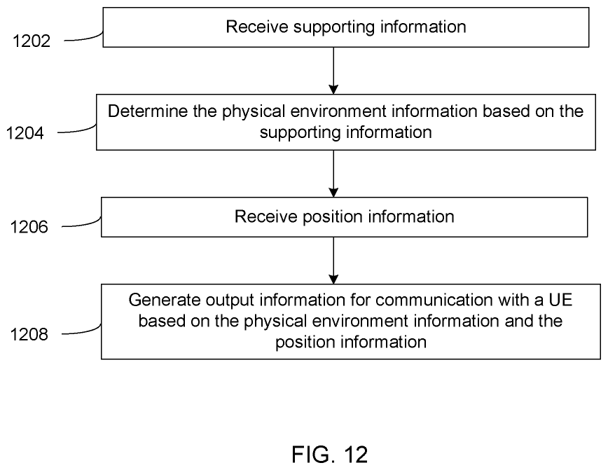

FIG. 12 illustrates a flowchart of an example method 1200 of a BS 102 generating output communication with a UE 116 using at least one learning model according to embodiments of the present disclosure.

The method 1200 begins with the BS 102 receiving supporting information from at least one external device (1202). As noted above, after the BS 102 registers the at least one external device based on service registration request(s) and transmits support related configuration information to the relevant external device(s) (operations 502-504) the BS 102 receives the supporting information from the external device(s).

Next, the BS 102 determines the physical environment information based on the supporting information (1204). As noted above, the BS 102 determines the physical environment information (506) by implementing at least one learning model.

Next, the BS receives position information from the UE 116 (1206). As noted above, The BS 102 receives position information from the UE 116 and uses it as an input to the learning model (operation 806).

Then, the BS (102) generates output information for communication with the UE (a DL transmission) based on the physical environment information and the position information using the at least one learning model (1208).

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for operating a base station (BS), the method comprising:
receiving supporting information from at least one external device;
determining physical environment information based on the supporting information;
receiving position information for a user equipment (UE); and
generating output information for communication with the UE based on the physical environment information and the position information using at least one learning model.

2. The method of claim 1, wherein receiving supporting information from the at least one external device comprises:
receiving a service registration request from the at least one external device;
registering the at least one external device and transmitting support related configuration information to the external device based on the service registration request; and
receiving the supporting information from the at least one external device based on the support related configuration information.

3. The method of claim 2, wherein the support related configuration information comprises at least one of: a type of reporting, entity related configuration information, and channel state information-reference signal (CSI-RS) pilot design and allocation to fixed wireless nodes.

4. The method of claim 1, wherein the supporting information comprises at least one of: channel state information (CSI) pilots, echo transmission signals, images, and videos.

5. The method of claim 1, wherein receiving the position information for a UE comprises:
receiving user compatibility information from the UE;
configuring the UE with positioning related configuration information based on the user compatibility information; and
receiving the position information based on the positioning related configuration information.

6. The method of claim 1, wherein generating the output information for communication with the UE based on the physical environment information comprises aggregating and tokenizing the supporting information and the position information using the at least one learning model.

7. The method of claim 1, wherein the at least one learning model includes at least one static learning model and at least one dynamic learning model, and generating the output information further comprises:
determining static scattering using the at least one static learning model using the position information and at least one of geographical information and three-dimensional spatial data; and
determining dynamic scattering using the at least one dynamic learning model based on the supporting information and the position information.

8. The method of claim 7, wherein the geographical information is a city geography markup language (CityGML) file.

9. The method of claim 1, further comprising:
receiving temporal support data included in a service registration request from the at least one external device; and
generating a channel state information (CSI) prediction model using the at least one learning model based on the temporal support data.

10. The method of claim 1, wherein the output information comprises at least one of precoder information and beam index information.

11. A base station (BS) comprising:
a transceiver;
a backhaul or network interface;
at least one processor including processing circuitry operably coupled to the transceiver and the backhaul or network interface; and
a memory storing instructions, wherein the instructions, when executed by the at least one processor individually or collectively, cause the BS to:
receive, via at least one of transceiver and the backhaul or network interface, supporting information from at least one external device;
determine physical environment information based on the supporting information;
receive position information for a user equipment (UE); and
generate output information for communication with the UE based on the physical environment information and the position information using at least one learning model.

12. The BS of claim 11, wherein receiving supporting information from the at least one external device comprises:
receiving a service registration request from the at least one external device;
registering the at least one external device and transmitting support related configuration information to the external device based on the service registration request; and
receiving the supporting information from the at least one external device based on the support related configuration information.

13. The BS of claim 12, wherein the support related configuration information comprises at least one of: a type of reporting, entity related configuration information, and channel state information-reference signal (CSI-RS) pilot design and allocation to fixed wireless nodes.

14. The BS of claim 11, wherein the supporting information comprises at least one of: channel state information (CSI) pilots, echo transmission signals, images, and videos.

15. The BS of claim 11, wherein receiving the position information for a UE comprises:
receiving user compatibility information from the UE;
configuring the UE with positioning related configuration information based on the user compatibility information; and
receiving the position information based on the positioning related configuration information.

16. The BS of claim 11, wherein generating the output information for communication with the UE based on the physical environment information comprises aggregating and tokenizing the supporting information and the position information using the at least one learning model.

17. The BS of claim 11, wherein the at least one learning model includes at least one static learning model and at least one dynamic learning model, and generating the output information further comprises:
determining static scattering using the at least one static learning model using the position information and at least one geographical information and three-dimensional spatial data; and
determining dynamic scattering using the at least one dynamic learning model based on the supporting information and the position information.

18. The BS of claim 17, wherein the geographical information is a city geography markup language (CityGML) file.

19. The BS of claim 11, further comprising:
receiving temporal support data included in a service registration request from the at least one external device; and
generating a channel state information (CSI) prediction model using the at least one learning model based on the temporal support data.

20. The BS of claim 11, wherein the output information comprises at least one of precoder information and beam index information.
